(19) United States
(12) Patent Application Publication
(10) Pub. No.: US 2025/0227573 A1
(43) Pub. Date: Jul. 10, 2025

(54) COMMUNICATION METHOD, APPARATUS AND DEVICE, STORAGE MEDIUM, CHIP, PRODUCT, AND PROGRAM

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN)

(21) Appl. No.: 19/089,525

(22) Filed: Mar. 25, 2025

Related U.S. Application Data
(63) Continuation of application No. PCT/CN2022/123266, filed on Sep. 30, 2022.

(51) Int. Cl. H04W 36/00; H04W 36/08; H04W 36/36

(52) U.S. Cl. CPC H04W 36/00835; H04W 36/0058; H04W 36/00725; H04W 36/08; H04W 36/362

(57) ABSTRACT

A communication method, apparatus and device, a storage medium, a chip, a product, and a program are provided. The method includes that: a terminal device determines a target cell or first information, the first information indicating the target cell; and the terminal device accesses the target cell via a random access procedure, or the terminal device triggers a connection reestablishment procedure, or the terminal device determines a first candidate cell, and executes a handover to the first candidate cell.

### CROSS-REFERENCE TO RELATED APPLICATION

This application is a continuation of International Patent Application No. PCT/CN2022/123266, filed on Sep. 30, 2022, the disclosure of which is hereby incorporated by reference in its entirety.

### RELATED ART

A terminal device may be handed over from a source cell to a target cell through a handover procedure. However, when the terminal device fails to be handed over, the terminal device may be unable to establish a connection with the target cell. Therefore, the terminal may be unable to communicate with the target cell, thereby reducing reliability of information transmission.

### SUMMARY

Embodiments of the disclosure relate to the technical field of mobile communications, and particularly to a communication method, a terminal device and a source network device.

In a first aspect, there is provided a communication method in an embodiment of the disclosure, and the method includes the following operations.

A target cell or first information is determined by a terminal device. The first information indicates the target cell.

The target cell is accessed by the terminal device through a random access procedure, or a connection reestablishment procedure is triggered by the terminal device, or a first candidate cell is determined by the terminal device and a handover is performed to the first candidate cell by the terminal device.

In a second aspect, there is provided a terminal device in an embodiment of the disclosure, and the terminal device includes a processor and a memory for storing a computer program executable on the processor.

The processor is configured to execute the computer program to cause the terminal device to determine a target cell or first information. The first information indicates the target cell.

The processor is further configured to execute the computer program to cause the terminal device to: access the target cell through a random access procedure, or trigger a connection reestablishment procedure, or perform handover to a first candidate cell determined by a terminal device.

In a third aspect, there is provided a network device in an embodiment of the disclosure, and the network device includes a processor and a memory for storing a computer program executable on the processor.

The processor is configured to execute the computer program to cause the network device to: transmit an identifier of a target cell or first information to a terminal device. The first information indicates the target cell.

The identifier of the target cell or the first information is used for the terminal device to access the target cell through a random access procedure, or to trigger a connection reestablishment procedure, or to determine a first candidate cell and perform handover to the first candidate cell.

### BRIEF DESCRIPTION OF THE DRAWINGS

The accompanying drawings, which are illustrated herein, provide a further understanding of the disclosure and constitute a part of the disclosure. The exemplary embodiments of the disclosure and their description are intended to explain the disclosure and not intended to unduly limit the disclosure. In the drawings:

FIG. 1 is a schematic diagram of an application scenario in an embodiment of the disclosure;

FIG. 2 is a schematic diagram of a handover procedure provided in an embodiment of the disclosure;

FIG. 3 is a schematic flowchart of a communication method provided in an embodiment of the disclosure;

FIG. 4 is a schematic flowchart of another communication method provided in an embodiment of the disclosure;

FIG. 5 is a schematic diagram of a structural composition of a communication apparatus provided in an embodiment of the disclosure;

FIG. 6 is a schematic diagram of a structural composition of another communication apparatus provided in an embodiment of the disclosure;

FIG. 7 is a schematic structural diagram of a communication device provided in an embodiment of the disclosure; and

FIG. 8 is a schematic structural diagram of a chip according to an embodiment of the disclosure.

### DETAILED DESCRIPTION

The technical solutions in the embodiments of the disclosure will be described below with reference to the accompanying drawings in the embodiments of the disclosure. It is apparent that the described embodiments are some embodiments of the disclosure rather than all of the embodiments. All other embodiments obtained by a person of ordinary skill in the art based on the embodiments of the disclosure without paying inventive efforts shall fall within the scope of protection of the disclosure.

The technical solutions described in the embodiments of the disclosure may be combined arbitrarily with each other, provided that they do not conflict with each other. In the description of the disclosure, the term “a plurality of” means two or more, unless otherwise explicitly and specifically defined.

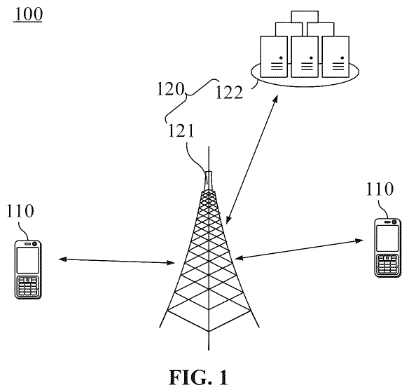

FIG. 1 is a schematic diagram of an application scenario in an embodiment of the disclosure. As illustrated in FIG. 1, a communication system 100 may include a terminal device 110 and a network device 120. The network device 120 may communicate with the terminal device 110 via an air interface. Multi-service transmission is supported between the terminal device 110 and the network device 120.

It should be understood that the embodiments of the disclosure are illustrated with reference to the communication system 100 only, but the embodiments of the disclosure are not limited thereto. In other words, the technical solutions in the embodiments of the disclosure may be applied to various communication systems, such as: a global system of mobile communication (GSM) system, a code division multiple access (CDMA) system, a wideband CDMA (WCDMA) system, a general packet radio service (GPRS) system, a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a universal mobile telecommunication system (UMTS), a wireless local area network (WLAN), a wireless fidelity (WiFi), an LTE time division duplex (TDD) system, a universal mobile telecommunication system (UMTS), an Internet of things (IoT) system, a narrow band IoT system, an enhanced machine-type communication (eMTC) system, or a further communication system (such as a 6th generation (6G) or 7G communication system), etc.

The network device 120 in the embodiment of the disclosure may include an access network device 121 and/or a core network device 122. The access network device may provide communication coverage to a particular geographic area, and may communicate with the terminal device 110 (such as user equipment (UE)) located within the coverage area.

The terminal device in the embodiments of the disclosure is a device with a wireless communication function, and the terminal device may be deployed on land, including indoors or outdoors, and may be hand-held or vehicle-mounted; or the terminal device may also be deployed on the water (such as ships, etc.), or may also be deployed in the air (such as airplanes, balloons and satellites, etc.). The terminal device in the embodiments of the disclosure may be referred to as user equipment (UE), a mobile station (MS), a mobile terminal (MT), a subscriber unit, a subscriber station, a mobile station, a remote station, a remote terminal, a mobile device, a user terminal, a terminal, a wireless communication device, a user agent, or a user apparatus. The terminal device may include one or a combination of at least two of the following devices: an IoT device, a satellite terminal, a wireless local loop (WLL) station, a personal digital assistant (PDA), a handheld device with a wireless communication function, a computing device or another processing device connected to a wireless modem, a server, a mobile phone, a Pad, a computer with a wireless transceiver function, a handheld computer, a desktop computer, a PDA, a portable media player, a smart speaker, a navigation device, a wearable device such as a smart watch, smart glasses, a smart necklace, a pedometer, a digital television (TV), a virtual reality (VR) terminal device, an augmented reality (AR) terminal device, a wireless terminal in an industrial control, a wireless terminal in a self-driving, a wireless terminal in a remote medical surgery, a wireless terminal in a smart grid, a wireless terminal in a transportation safety, a wireless terminal in a smart city, a wireless terminal in a smart home, a vehicle, an in-vehicle device, an in-vehicle module in an Internet of vehicle, a wireless modem, a handheld device, a customer premise equipment (CPE), a smart home appliance, etc.

Optionally, the terminal device 110 may be any terminal device including but not limited to a terminal device connected to the network device 120 or other terminal devices in a wired or wireless manner.

Optionally, the terminal device 110 may be applied to a device to device (D2D) communication.

The access network device 121 may include one of or a combination of at least two of the following devices: an evolutional node B (eNB or eNodeB) in an LTE system, a next generation radio access network (NG RAN) device, a base station in an NR system (gNB), a small station, a micro station, a wireless controller in a cloud radio access network (CRAN), an access point in WiFi, a transmission reception point (TRP), a relay station, an access point, an in-vehicle device, a wearable device, a hub, a switch, a bridge, a router, a network device in a future evolved public land mobile network (PLMN) or the like.

The core network device 122 may be a 5G core (5GC) device, and the core network device 122 may include one of or a combination of at least two of: an access and mobility management function (AMF), an authentication server function (AUSF), a user plane function (UPF), a session management function (SMF), a location management function (LMF), or a policy control function (PCF). In some other implementations, the core network device may also be an evolved packet core (EPC) device in the LTE network, for example, an SMF+core packet gateway (SMF+PGW-C) device. It should be understood that the SMF+PGW-C may achieve functions that can be achieved by both the SMF and PGW-C. In a process of network evolution, the core network device 122 may also be called by other names, or the functions of the core network may be divided to form a new network entity, which is not limited by the embodiments of the disclosure.

Various functional units in the communication system 100 may also be connected with each other through a next generation (NG) interface to realize communication.

For example, the terminal device may establish an air interface connection with the access network device through an NR interface, to transmit user plane data and control plane signaling. The terminal device may establish a control plane signaling connection with the AMF through an NG interface 1 (N1 for short). The access network device such as a next generation radio access base station (gNB) may establish a user plane data connection with the UPF through an NG interface 3 (N3 for short). The access network device may establish a control plane signaling connection with the AMF through an NG interface 2 (N2 for short). The UPF may establish a control plane signaling connection with the SMF through an NG interface 4 (N4 for short). The UPF may interact user plane data with a data network through an NG interface 6 (N6 for short). The AMF may establish a control plane signaling connection with the SMF through an NG interface 11 (N11 for short). The SMF may establish a control plane signaling connection with the PCF through an NG interface 7 (N7 for short).

FIG. 1 illustrates a base station, a core network device and two terminal devices in as an example. Optionally, the wireless communication system 100 may include multiple base stations and a coverage of each base station may include other numbers of terminal devices, which is not limited in the embodiments of the disclosure.

It should be noted that FIG. 1 illustrates the system to which the disclosure is applicable by way of example only, and the methods illustrated in the embodiments of the disclosure may also be applicable to other systems. Moreover, terms “system” and “network” are usually interchangeably used in the disclosure. The term “and/or” herein is only used to describe an association relationship between associated objects, and represents that three relationships may exist. For example, A and/or B may represent three conditions: i.e., independent existence of A, existence of both A and B and independent existence of B. In addition, the character “/” in the disclosure usually represents that previous and next associated objects form an “or” relationship. It should also be understood that the term “indication” mentioned in the embodiments of the disclosure may be a direct indication or an indirect indication, and may also be indicative of an associated relationship. For example, A indicates B, which may represent that A directly indicates B, for example, B may be obtained through A; or that A indirectly indicates B, for example, A indicates C, and B may be obtained through C; or that there is an association between A and B. It should also be understood that the term “correspondence” mentioned in the embodiments of the disclosure may indicate a direct or indirect correspondence between associated objects, or indicate an association relationship between the objects, or a relationship of indicating and being indicated, configuring and being configured, etc. It should also be understood that the phrases “predefining”, “defined in a protocol”, “predetermining” or “predefined rule” mentioned in the embodiments of the disclosure may be implemented by pre-storing corresponding codes or tables in devices (such as terminal devices and network devices), or by other means that may be used for indicating relevant information, the specific implementation of which is not limited in the disclosure. For example, predefinition may mean that it is defined in the protocol. It should also be understood that, in the embodiments of the disclosure, the “protocol” may be a standard protocol in the communication field, including such as an LTE protocol, an NR protocol, and related protocols to be applied in a future communication system, which are not limited herein.

In order to facilitate the understanding of the technical solutions in the embodiments of the disclosure, related technologies for the embodiments of the disclosure will be described below. The following related technologies may be used as optional solutions and may be arbitrarily combined with the technical solutions in the embodiments of the disclosure, and the combinations thereof fall within the scope of protection of the embodiments of the disclosure.

When a terminal device that is using a network service moves from a cell to another cell, or due to adjustment of a wireless transmission service load, activation operation and maintenance, equipment failure, etc., the system need to transfer a communication link between the terminal device and a source cell to a new target cell, that is, to perform a handover procedure, so as to ensure a continuity of communication and a service quality.

FIG. 2 is a schematic diagram of a handover procedure provided in an embodiment of the disclosure. As illustrated in FIG. 2, an Xn interface handover process is taken as an example, and the entire handover process may be divided into the following three stages.

(1) Handover preparation: including measurement control and reporting, handover request and acknowledgment. A handover acknowledgment message contains a handover command generated by a target cell, a source cell is not allowed to make any modification to the handover command generated by the target cell, and the source cell directly forwards the handover command to a terminal device.

(2) Handover execution: the terminal device executes a handover process immediately after receiving the handover command, that is, the terminal device detaches from the source cell and connects to the target cell (for example, the terminal device performs a random access procedure, transmits an radio resource control (RRC) handover completion message to a target base station, etc.). A sequence number (SN) status transfer and data forwarding are performed.

(3) Handover completion: the target base station performs a path switch with an AMF and a UPF, to release a terminal device context from a source base station.

In FIG. 2, the handover procedure may include the following operations 1 to 12.

Prior to the operation 1, the terminal device communicates user data with the source base station, and the source base station communicates user data with the UPF(s). Prior to the operation 1, there may be an operation 0: mobility control information is provided by the AMF.

In any of the embodiments of the disclosure, the source base station may be a base station corresponding to the source cell or a network device corresponding to the source cell, and the target base station may be a base station corresponding to the target cell or a network device corresponding to the target cell.

Operation 1: measurement control and reporting are performed. The source base station configures a measurement configuration for the terminal device, and a measurement result from the terminal device is used for assisting the source base station in making a handover decision. Then, the terminal device performs a measurement reporting based on the measurement configuration.

Operation 2: a handover decision is performed. The source base station makes the handover decision based on the measurement reporting result of the terminal device in combination with its own handover algorithm.

Operation 3: the source base station transmits a handover request to the target base station. The source base station transmits a handover request message to the target base station, the handover request message includes information related to the handover preparation, mainly including X2 and SI signaling context references of the terminal device, an identifier of the target cell, a key, an RRC context, an access stratum (AS) configuration, an evolved universal terrestrial radio access network (E-UTRAN) radio access bearer (E-RAB) context, etc. The message also includes a physical layer identifier of the source cell and a message authentication verification code for a recovery process after a possible handover failure. The X2 and SI signaling context references of the terminal device may assist the target base station in finding a location of the source base station. The E-RAB context includes a necessary radio network layer (RNL) and a transport network layer (TNL), addressing information, quality of service (QOS) information of the E-RAB, and the like. Part of the handover preparation information is contained in an interface message (such as the identifier of the target cell), and the other part is present in an RRC container of the interface message (such as the RRC context).

Operation 4: an admission control is performed. The target base station performs the admission control based on the received E-RAB QOS information, to improve a success rate of handover. The admission control should consider reserving a corresponding resource and a cell radio network temporary identity (C-RNTI), and allocating a dedicated random access preamble, etc. An AS configuration used by the target cell may be a full configuration completely independent of the source cell, or may be an incremental configuration based on the source cell (the incremental configuration means that the same part is not configured, and only a different part is reconfigured through signaling, and the terminal device will continue to use the original configuration when the configuration is not received).

Operation 5: the target base station sends a handover request acknowledgement (ACK) to the source base station. The target base station performs the handover preparation, and sends the handover request ACK message to the source base station. The handover request ACK message includes an RRC container, and the specific content is a handover command that triggers the terminal device to perform the handover. The source base station transmits the handover command to the terminal device transparently (without any modification). The handover command includes a new C-RNTI and a case algorithm identifier of the target base station, and may also carry a dedicated random access preamble, an access parameter, system information, etc. The handover request ACK message, if necessary, may also carry the RNL/TNL information for data forwarding. The source base station may start the data forwarding after receiving the handover request ACK message or forwards the handover command to the terminal device.

Operation 6: an RAN handover is initiated. In the operation 6, the source base station transmits the handover command to the terminal device. The handover command (i.e., an RRC connection reconfiguration message carrying the mobility control information) is generated by the target base station and transparently transmitted to the terminal device through the source base station. The terminal device may use relevant parameters in the message to initiate the handover process after receiving the message. The terminal device may initiate the handover process without waiting for a hybrid automatic repeat request (HARQ)/automatic repeat request (ARQ) response transmitted by a lower layer to the source base station.

After the operation 6, the terminal device detaches from the source base station and synchronises to the target base station.

Operation 7: the source base station performs an SN transfer to the target base station, and the SN transfer may also be an SN status transfer. The source base station sends an SN status transfer message to the target base station, and transmits an uplink packet data convergence protocol (PDCP) SN reception status and a downlink PDCP SN transmission status of E-RABs (only those E-RABs that are required to retain the PDCP status need to transfer the SN status, which corresponds to a radio link control (RLC) acknowledged mode (AM)).

After the operation 7, the source base station delivers buffered data and new data from the UPF(s). Then, the UPF may first transmit the user data, to be transmitted to the terminal device, to the source base station, then the source base station may forward the user data to the target base station, and the target base station may buffer the user data from the source base station.

Operation 8: the RAN handover is completed. In the operation 8, after receiving the handover command, the terminal device performs synchronization with the target cell. If the dedicated random access preamble is configured in the handover command, the target cell is accessed by using a non-contention random access procedure. If the dedicated preamble is not configured, the target cell is accessed by using a contention-based random access procedure.

After the operation 8, the terminal device will transmit the user data to the UPF through the target base station.

Operation 9: the target base station sends a path switch request to the AMF. The path switch request from the target base station enables the AMF to know that the terminal device has switched the cell. At this time, the handover of the air interface has been completed successfully.

Operation 10: the path switch in the UPF may be realized by the following operations: the AMF sends a user plane update request to the UPF, the UPF switches a downlink data path, and the UPF sends a user plane update response to the AMF.

In order to assist a rearrangement function at the target base station, the UPF sends one or more “End Marker packets” on the old path immediately after switching the path. The “End Marker packet” contains no user data and is indicated by a GPRS tunneling protocol (GTP) header. After finishing the transmission of the packet containing the marker, the UPF should not transmit any packets in the old path. After receiving the “End Marker packet”, if forwarding is active for this bearer, the source base station should send this packet to the target base station. The target base station, upon detecting the “End Marker packet”, may discard the “End Marker packet” and initiate any necessary procedure to maintain sequential delivery of the user, so that the user data is transmitted between the UPF and the target base station.

Operation 11: the AMF transmits a path switch request ACK to the target base station, and the path switch process is completed.

Operation 12: the target base station transmits a terminal device context release message to the source base station, and the source base station receives the terminal device context release message from the target base station, to release the context of the terminal device.

In order to reduce a delay caused by the handover, NR Release 18 (R18) supports a handover based on layer1/layer2 (L1/L2). The L1/L2-based handover is mainly for intra-central unit (intra-CU) handover scenarios. The handover is performed based on an L1 or L2 signaling in case that the PDCP and/or a key of the central unit (CU) remain unchanged.

LTE R14 introduces a random access channel-less (RACH-less) handover. A timing advance (TA) value of the terminal device is 0 or the same as the TA value of the source cell. After receiving the handover command, the terminal device may directly perform an uplink transmission to the target base station. For the RACH-less handover, a determination condition that the handover of the terminal device is completed is that the terminal device receives a contention resolution identity media access control control element (MAC CE) of the terminal device from the target cell.

In any of the embodiments of the disclosure, the TA may also be referred to as a time advance amount, a time advance, or a TA amount. In any of the embodiments of the disclosure, RACH-less may be understood in the same way as RACH less.

For the L1/L2-based handover, reduction of the delay of UE uplink synchronization is one of main optimization directions for L1/L2 mobility. One way is to obtain the TA of UE in the target cell in advance. That is, when the handover is triggered, the UE does not need to perform the random access procedure for acquiring the TA again, but may perform interaction with the target cell based on the acquired TA.

A potential problem for acquiring the TA in advance is that, the TA may no longer be valid due to the movement of the UE when the UE actually performs the handover, or a link quality corresponding to a beam indicated by the network in the handover command does not satisfy the transmission requirements, and then the UE can only try to perform the uplink transmission until T304 expires and the handover is considered to have failed.

In order to avoid an RRC connection reestablishment procedure due to the above handover failure, the disclosure provides a method that can fall back to the traditional random access, to avoid an unnecessary reestablishment procedure.

For the convenience of understanding the technical solutions in the embodiments of the disclosure, the technical solutions in the disclosure will be described in detail below by means of detailed embodiments. The above related technologies are used as optional solutions and may be arbitrarily combined with the technical solutions in the embodiments of the disclosure, and the combinations thereof fall within the scope of protection of the embodiments of the disclosure. The embodiments of the disclosure include at least part of the following contents.

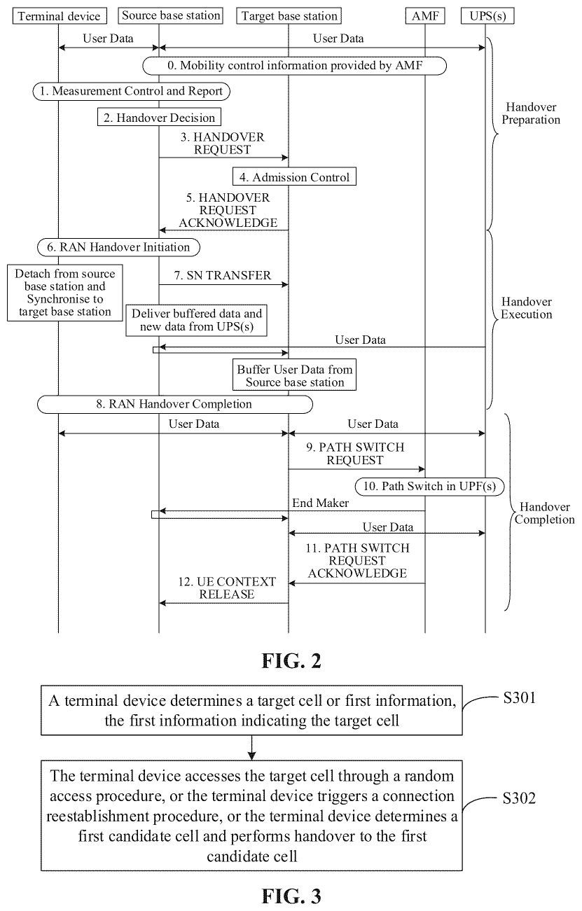

FIG. 3 is a schematic flowchart of a communication method provided in an embodiment of the disclosure. As illustrated in FIG. 3, the method includes the following operations.

At S301, a terminal device determines a target cell or first information. The first information indicates the target cell.

At S302, the terminal device accesses the target cell through a random access procedure, or the terminal device triggers a connection reestablishment procedure, or the terminal device determines a first candidate cell and performs handover to the first candidate cell.

Optionally, the terminal device may determine the target cell or the first information based on a measurement result for at least one candidate cell. Optionally, the terminal device may perform measurement on the at least one candidate cell, to obtain the measurement result for the at least one candidate cell. Optionally, the measurement result for the at least one candidate cell may be included in a measurement report.

Optionally, the terminal device may receive an identifier of the target cell or the first information from a (source) network device.

Optionally, the first information may include or indicate the identifier of the target cell. Optionally, the first information may further include or indicate information for accessing or handing over to the target cell. Optionally, when the first information is transmitted by the (source) network device to the terminal device, the first information may be included in a handover command or a reconfiguration message, or may be included in another signaling in the reconfiguration message.

Optionally, the operation that the terminal device accesses the target cell through the random access procedure may include that: the terminal device accesses the target cell through the random access procedure based on random access information of the target cell. Optionally, the random access information may include at least one of: a random access preamble, a random access resource, or a TA value.

Optionally, in any of the embodiments of the disclosure, the TA value may include an uplink TA value or a downlink TA value.

Optionally, the random access information of the target cell may be determined by the terminal device, or may be determined by the network device and transmitted to the terminal device. Optionally, the random access information of the target cell may be included in the handover command, or may be included in the reconfiguration message, or may be included in another signaling in the reconfiguration message.

Optionally, the operation that the terminal device triggers the connection reestablishment procedure may include that: the terminal device transmits a connection reestablishment request to a specific network device. Optionally, in some embodiments, the terminal device may receive a connection reestablishment message from the specific network device, and the terminal device may transmit a connection reestablishment completion message to the specific network device. Optionally, in some other embodiments, the terminal device may receive a connection reestablishment rejection message from the specific network device. Optionally, a cell corresponding to the specific network device may be any cell that can be searched by the terminal device. For example, the specific network device may include any one of the following network devices: a source network device corresponding to a source cell, a target network device corresponding to the target cell, a network device corresponding to the first candidate cell, a network device corresponding to the at least one candidate cell, or a network device corresponding to a cell other than the at least one candidate cell.

Optionally, the terminal device may determine the first candidate cell by itself and perform the handover to the first candidate cell. Optionally, the terminal device may determine the first candidate cell based on the measurement result for the at least one candidate cell. Optionally, the terminal device may determine the first candidate cell from the at least one candidate cell.

Optionally, the first information or the handover command may include the first candidate cell. Optionally, TA values of at least two of the first candidate cell, the target cell, or the source cell may be the same or different.

Optionally, the operation of performing the handover to the first candidate cell may include one of: obtaining a TA value of the first candidate cell and performing the handover to the first candidate cell based on the TA value of the first candidate cell, or initiating a random access procedure to access the first candidate cell.

Optionally, the operation that the terminal device triggers the connection reestablishment procedure or the terminal device determines the first candidate cell and performs the handover to the first candidate cell may include that: the terminal device triggers the connection reestablishment procedure or determines the first candidate cell and performs the handover to the first candidate cell based on at least one of: cell information of the target cell, accessing information of the target cell, or information for accessing and/or handing over to the target cell.

Optionally, when the terminal device determines that the target cell is unable to be accessed, the terminal device triggers the connection reestablishment procedure, or the terminal device determines the first candidate cell and performs the handover to the first candidate cell. Optionally, the operation that the terminal device determines that the target cell is unable to be accessed may include that: the terminal device determines that the target cell is unable to be accessed based on the information, for accessing or handing over to the target cell, which is obtained in advance or transmitted by the source network device.

Optionally, when determining the first candidate cell, the terminal device may access the first candidate cell by a TA value of the first candidate cell.

Optionally, when determining the first candidate cell, the terminal device may access the first candidate cell through the random access procedure. Optionally, the operation that the terminal device accesses the first candidate cell through the random access procedure may include that: the terminal device accesses the first candidate cell through the random access procedure based on random access information of the first candidate cell. Optionally, the random access information may include at least one of: a random access preamble, a random access resource, or a TA value.

Optionally, the random access information of the target cell and/or the random access information of the first candidate cell may be pre-configured by the terminal device, or may be configured/activated by the source network device for the terminal device, or may be defined in a protocol. Illustratively, the random access information of the target cell and/or the random access information of the first candidate cell may be included in a signaling/configuration indicating at least one candidate cell, or may be included in the handover command. Optionally, the random access resource of the target cell and/or the random access resource of the first candidate cell may be a configured grant (CG) resource or a dynamic grant (DG) resource.

Optionally, when the terminal device fails to access the target cell through the random access procedure, the terminal device triggers the connection reestablishment procedure, or the terminal device determines the first candidate cell and performs the handover to the first candidate cell.

Optionally, when the terminal device fails to trigger the connection reestablishment procedure, the terminal device determines the first candidate cell and performs the handover to the first candidate cell.

Optionally, when the terminal device fails to access the target cell through the random access procedure, the terminal device triggers the connection reestablishment procedure, and when the terminal device fails to trigger the connection reestablishment procedure, the terminal device determines the first candidate cell and performs the handover to the first candidate cell.

In the embodiments of the disclosure, the terminal device determines the target cell or the first information. The first information indicates the target cell. The terminal device accesses the target cell through the random access procedure, or the terminal device triggers the connection reestablishment procedure, or the terminal device determines the first candidate cell and performs handover to the first candidate cell. In such a way, the terminal device can access the target cell through the random access procedure, or can access any cell through the connection reestablishment procedure, or can access the first candidate cell, such that the terminal device can communicate in the target cell or the first candidate cell, and the reliability of information transmission is improved.

In some embodiments, the operation that the terminal device accesses the target cell through the random access procedure includes that: when the terminal device fails to access the target cell within a first duration, the terminal device accesses the target cell through the random access procedure.

Optionally, when the terminal device fails to access the target cell, the terminal device accesses the target cell through the random access procedure, which may include that: the terminal device fails to access the target cell by one or more access methods other than the random access procedure. Optionally, the one or more access methods other than the random access procedure may include at least one of: the terminal device directly accessing the target cell (corresponding to the RACH-less handover), or the terminal device accessing the target cell based on an obtained TA value of the target cell (corresponding to the L1/L2 handover).

Optionally, in any of the embodiments of the disclosure, the accessing operation may include that: the terminal device performs an uplink transmission or monitors a downlink message based on an acquired resource. For example, the operation of accessing the target cell may include that: the terminal device transmits an uplink message (e.g., second information) to the target network device based on the acquired resource, or the terminal device monitors the downlink message (e.g., a physical downlink control channel (PDCCH) or a physical downlink shared channel (PDSCH)) transmitted by the target network device based on the acquired resource. For another example, the operation of accessing the specific cell (i.e., the cell corresponding to the specific network device)/the first candidate cell may include that: the terminal device transmits the uplink message to the specific network device/the network device corresponding to the first candidate cell based on the acquired resource, or the terminal device monitors the downlink message transmitted by the specific network device/the network device corresponding to the first candidate cell based on the acquired resource.

Optionally, the first duration may be less than a duration of a timer T304. Optionally, a starting time of the first duration may be the same as a starting time of the timer T304. Optionally, the first duration may be determined based on pre-configuration information of the terminal device, or may be configured by the network device for the terminal device, or may be defined in a protocol. Optionally, the first duration may be configured by the source network device through an RRC signaling.

Optionally, the first duration may be the timer T304. In this case, when the timer T304 expires, the terminal device may perform the operation of accessing the target cell through the random access procedure.

In some embodiments, the random access procedure includes a four-step random access procedure or a two-step random access procedure.

In some embodiments, the operation that the terminal device fails to access the target cell includes that: the terminal device does not receive third information from a target network device after transmitting second information to the target network device.

Optionally, the terminal device may transmit the second information through an uplink resource when the terminal device has an available uplink resource. Optionally, the available uplink resource may be pre-configured by the source network device for the terminal device. For example, an indication of the uplink resource may be included in a signaling/configuration for indicating the at least one candidate cell to the terminal device. Alternatively, the available uplink resource may be directly indicated or activated by the source network device to the terminal device (e.g., by activating the pre-configured resources). For example, an indication of the uplink resource may be included in the handover command, or the available uplink resource may be defined in the protocol. Optionally, the uplink resource in any of the embodiments of the disclosure may be a CG resource or a DG resource.

In some other embodiments, the operation that the terminal device fails to access the target cell includes that: the terminal device does not monitor a PDCCH or PDSCH transmitted by the target network device.

Optionally, the terminal device may receive the second information, the PDCCH, or the PDSCH in a downlink resource. Optionally, the downlink resource may be pre-configured by the terminal device, or may be configured by the source network device for the terminal device, or may be defined in the protocol.

Optionally, the terminal device monitors the PDCCH or the PDSCH from the target cell when no uplink resource is available.

Optionally, the PDCCH is used for scheduling or activating the uplink resource and/or the downlink resource.

In some embodiments, the second information includes at least one of: a reconfiguration completion message, a handover execution/completion MAC CE, a C-RNTI MAC CE, a buffer status report (BSR), a data message, or a scheduling request (SR).

In some embodiments, the third information includes at least one of: a contention resolution identity MAC CE of the terminal device, or downlink information.

Optionally, the downlink information in any of the embodiments of the disclosure may include at least one of: downlink data information, a PDCCH, a PDSCH, downlink control information (DCI), or a downlink MAC CE.

In some embodiments, the operation that the terminal device accesses the target cell through the random access procedure includes the following operation.

The terminal device transmits an Msg3/MsgA to the target network device. When a grant size for transmitting an Msg3/MsgA payload is greater than or equal to an uplink MAC protocol data unit (PDU), the uplink MAC PDU is transmitted to the target network device through the Msg3/MsgA.

In some embodiments, the operation that the terminal device accesses the target cell through the random access procedure includes the following operation.

The terminal device transmits an Msg3/MsgA to the target network device. When a grant size for transmitting an Msg3/MsgA payload is less than the uplink MAC PDU, part or all of MAC service data units (SDUs) and/or part or all of MAC CEs are determined from the uplink MAC PDU, and the part or all of the MAC SDUs and/or the part or all of the MAC CEs are transmitted to the target network device through the Msg3/MsgA.

Optionally, at least one of the uplink MAC PDU, the MAC SDU, or the MAC CE may correspond to an entire or part of the second information.

In some embodiments, the method further includes that: the terminal device determines a TA value of the target cell, and the operation that the terminal device accesses the target cell through the random access procedure includes that: the terminal device accesses the target cell through the random access procedure after a second duration has elapsed from a time when the terminal device determines the TA value of the target cell.

Optionally, the terminal device may determine the TA value of the target cell before or after the terminal device determines the target cell or the first information, or the terminal device may determine the TA value of the target cell while determining the target cell or the first information. Illustratively, in some scenarios, the terminal device may determine the TA value of the target cell before the terminal device determines the target cell or the first information.

Optionally, the terminal device may determine the TA value of the target cell by itself, or the terminal device may receive the TA value of the target cell from the source network device. Optionally, the terminal device may first determine the TA value of the target cell, and then determine the target cell or the first information, such that the terminal device accesses the target cell based on the TA value of the target cell. Optionally, the terminal device may first determine a TA value of at least one candidate cell, and then the terminal device may determine the target cell or the first information, such that the terminal device accesses the target cell based on the TA value of the target cell. The at least one candidate cell includes the target cell.

Optionally, the second duration may be determined based on pre-configuration information of the terminal device, or may be configured by the network device for the terminal device, or may be defined in the protocol. Optionally, a starting time of the second duration may be a time when the TA value of the target cell is determined, or may be determined based on the time when the TA value of the target cell is determined. Optionally, the second duration may be configured by the source network device through an RRC signaling.

Optionally, the second duration may be greater than a specific duration. The specific duration may be a duration between the time when the terminal device determines the TA value of the target cell and a time when the terminal device determines the target cell or the first information.

In some embodiments, the operation that the terminal device accesses the target cell through the random access procedure after the second duration has elapsed from the time when the terminal device determines the TA value of the target cell includes the following operation. When the terminal device fails to access the target cell based on the TA value of the target cell within the second duration from the time when the terminal device determines the TA value of the target cell, the terminal device accesses the target cell through the random access procedure after the second duration has elapsed.

In some embodiments, the operation that the terminal device determines the TA value of the target cell includes that the terminal device receives the TA value of the target cell from the source network device.

Optionally, the TA value of the target cell may be included in the handover command, or may be included in the reconfiguration message, or may be included in another signaling in the reconfiguration message. Optionally, the source network device may determine a TA value between the source network device and the terminal device, obtain a TA difference between the TA value of the source cell and the TA value of the target cell, and determine the TA value of the target cell based on the TA value between the source network device and the terminal device, and the TA difference.

In some other embodiments, the operation that the terminal device determines the TA value of the target cell includes that: the terminal device transmits an uplink reference signal to the source network device, and receives the TA value of the target cell from the source network device.

Optionally, the uplink reference signal may include at least one of: a sounding reference signal (SRS), a demodulation reference signal (DMRS), or a phase tracking reference signal (PTRS).

Optionally, the source network device may transmit configuration information for the uplink reference signal to the terminal device, and the terminal device may transmit the uplink reference signal to the source network device based on the configuration information for the uplink reference signal. Optionally, the source network device may determine the TA value between the source network device and the terminal device based on the uplink reference signal transmitted by the terminal device, and then the source network device may determine the TA value of the target cell based on the TA value between the source network device and the terminal device and the TA difference. Optionally, the configuration information for the uplink reference signal may include a resource for transmitting the uplink reference signal.

In some other embodiments, the operation that the terminal device determines the TA value of the target cell may include that: the terminal device determines the TA value of the target cell based on a first measurement result for the target cell.

Optionally, the terminal device may receive at least one candidate cell from the source network device, and the terminal device may perform measurement on the at least one candidate cell to obtain a measurement result for the at least one candidate cell. Because the at least one candidate cell includes the target cell, the terminal device can obtain the first measurement result for the target cell. Optionally, the measurement result for the at least one candidate cell may be included in a measurement report.

Optionally, the terminal device performs measurement on the at least one candidate cell based on the configuration information, to obtain the measurement result for the at least one candidate cell. The at least one candidate cell may include the source cell and the target cell, and the terminal device may determine whether a handover to the target cell is required based on the measurement result for the at least one candidate cell. In this case, the terminal may obtain the first measurement result for the target cell before determining the target cell to be handed over, and may further determine the TA value of the target cell.

Optionally, in any of the embodiments of the disclosure, the measurement result may include at least one of: a reference signal received power (RSRP), a reference signal received quality (RSRQ), a received signal strength indicator (RSSI), or a signal to interference and noise ratio (SINR).

In some other embodiments, the operation that the terminal device determines the TA value of the target cell may include that: the terminal device determines the TA value of the target cell based on a TA value of a source cell and a difference between the TA value of the source cell and the TA value of the target cell.

Optionally, the terminal device may receive the difference between the TA value of the source cell and the TA value of the target cell from the source network device. Optionally, the TA value of the source cell and/or the TA different value between the TA value of source cell and the TA value of the target cell may be included in the handover command, or may be included in the reconfiguration message, or may be included in another signaling in the reconfiguration message.

In some other embodiments, the operation that the terminal device determines the TA value of the target cell may include that: the terminal device determines the TA value of the target cell through the random access procedure. Thus, in an implementation, the terminal device may determine the TA value of the target cell through the random access procedure before the terminal device determines the target cell or the first information. When the terminal device fails to access the target cell based on the TA value of the target cell, the terminal device may determine a new TA value of the target cell through the random access procedure and access the target cell by using the new TA value.

Optionally, the random access procedure may be triggered by a PDCCH order or a DCI, to enable the terminal device to determine the TA value of the target cell. For example, the source network device may transmit the PDCCH order or the DCI to the terminal device, and the terminal device initiates the random access procedure based on the PDCCH order or the DCI to obtain the TA value of the target cell.

In some embodiments, the method may further include the following operations.

The terminal device determines a first measurement result for the target cell before the terminal device determines the target cell or the first information. A time when the terminal device determines the first measurement result for the target cell corresponds to a time when the terminal device determines the TA value of the target cell.

The terminal device determines a second measurement result for the target cell when the terminal device receives a handover command from a source network device or when the terminal device is required to perform the handover.

The operation that the terminal device accesses the target cell through the random access procedure includes the following operation.

The terminal device accesses the target cell through the random access procedure when an absolute value of a difference between the first measurement result and the second measurement result is greater than a first threshold.

Optionally, the first measurement result for the target cell may be a measurement result in the measurement report. Optionally, the first measurement result for the target cell may be determined before the terminal device determines that it is required to perform the handover to the target cell.

Optionally, the time when the first measurement result for the target cell is determined may be the same as the time when the TA value of the target cell is determined, or the time when the first measurement result for the target cell is determined may be separated from the time when the TA value of the target cell is determined by one or more time units. Optionally, the time unit may include or may consist of at least one of: one or more frames, one or more subframes, one or more slots, or one or more symbols. Optionally, the first measurement result for the target cell may be determined before or after the TA value of the target cell is determined, or the first measurement result for the target cell may be determined while determining the TA value of the target cell.

When the terminal device receives the handover command from the source network device or when the terminal device is required to perform the handover, the terminal device may determine that it is required to perform the handover to the target cell.

In the related art, when the terminal device receives the handover command from the source network device or when the terminal device is required to perform the handover, the terminal device may directly transmit a message to the target network device based on the TA value of the target cell. However, in the embodiments of the disclosure, when the terminal device receives the handover command from the source network device or when the terminal device is required to perform the handover, the terminal device re-determines a second measurement result for the target cell and further determines a manner for accessing the target cell by the terminal device based on the first measurement result and the second measurement result.

Illustratively, the terminal device accesses the target cell through the random access procedure when the absolute value of the difference between the first measurement result and the second measurement result is greater than the first threshold.

In the embodiment of the disclosure, the terminal device determines that the TA value of the target cell does not satisfy an access requirement when the absolute value of the difference between the first measurement result and the second measurement result is larger than the first threshold. In such a situation, the terminal device may determine a new TA value of the target cell through the random access procedure, and may access the target cell based on the new TA value of the target cell. Therefore, the situation that the transmission reliability is reduced, due to the fact that the target cell cannot be accessed through the TA value of the target cell, can be avoided.

Optionally, in any of the embodiments of the disclosure, the TA value of the target cell may be referred to as an old TA value of the target cell or a first TA value of the target cell, and the new TA value of the target cell may be referred to as a second TA value of the target cell.

In some embodiments, the method may further include the following operation.

The terminal device performs the handover to the target cell when the absolute value of the difference between the first measurement result and the second measurement result is less than or equal to the first threshold.

In such a situation, when the absolute value of the difference between the first measurement result and the second measurement result is less than or equal to the first threshold, the terminal device may perform the handover to the target cell based on the TA value of the target cell, in other words, the terminal device may access the target cell based on the TA value of the target cell.

Optionally, the first threshold may be determined based on pre-configuration information of the terminal device, or may be configured by the network device for the terminal device, or may be defined in the protocol.

In the embodiment of the disclosure, the terminal device determines that the TA value of the target cell satisfies the access requirement when the absolute value of the difference between the first measurement result and the second measurement result is less than or equal to the first threshold, and the terminal device may perform the handover to the target cell based on the TA value of the target cell.

In some embodiments, the operation that the terminal device accesses the target cell through the random access procedure includes the following operation.

The terminal device accesses the target cell through the random access procedure when the terminal device determines that a measurement result for beam information of the target cell is less than or equal to a second threshold. The beam information of the target cell is indicated by the first information.

In some other embodiments, the operation that the terminal device accesses the target cell through the random access procedure includes that: the terminal device accesses the target cell through the random access procedure when the terminal device determines that no beam information with a measurement result greater than a second threshold is present in beam information of the target cell.

Optionally, the beam information may include a reference signal and/or resource information of the reference signal.

Optionally, in any of the embodiments of the disclosure, the beam information may be replaced with a reference signal or a downlink reference signal, that is, the beam information of the target cell may be replaced with a downlink reference signal of the target cell. Alternatively, in any of the embodiments of the disclosure, the beam information may correspond to a spatial domain filter. For example, a transmission beam may correspond to a spatial domain transmission filter, and a reception beam may correspond to a spatial domain receive filter.

Optionally, the downlink reference signal may include at least one of: a synchronization signal block (SSB), or a channel state information-reference signal (CSI-RS). The SSB may also be referred to as a synchronization signal/physical broadcast channel block (SS/PBCH block).

Optionally, the beam information of the target cell may be determined based on the pre-configuration information of the terminal device, or may be configured by the network device for the terminal device, or may be defined in the protocol. Optionally, the beam information of the target cell may be included in the first information, or may be included in the handover command, or may be included in the reconfiguration message, or may be included in another signaling in the reconfiguration message.

Optionally, the second threshold may be determined based on the pre-configuration information of the terminal device, or may be configured by the network device for the terminal device, or may be defined in the protocol.

In this way, the terminal device determines that the TA value of the target cell does not satisfy the access requirement when the measurement result for the beam information of the target cell is less than or equal to the second threshold or when no beam information with the measurement result greater than the second threshold is present in the beam information of the target cell. Then, the terminal device may determine a new TA value of the target cell through the random access procedure, and may access the target cell based on the new TA value of the target cell.

In some embodiments, the method further includes that: the terminal device performs the handover to the target cell when the terminal device determines that the measurement result for the beam information of the target cell is greater than the second threshold.

In some other embodiments, the method further includes that: the terminal device performs the handover to the target cell when the terminal device determines that the beam information with the measurement result greater than the second threshold is present in the beam information of the target cell.

In this way, the terminal device determines that the TA value of the target cell satisfies the access requirement when the measurement result for the beam information of the target cell is greater than the second threshold or when the beam information with the measurement result greater than the second threshold is present in the beam information of the target cell. Therefore, the terminal device may perform the handover to the target cell based on the TA value of the target cell.

In some embodiments, the operation that the terminal device triggers the connection reestablishment procedure or the terminal device determines the first candidate cell and performs the handover to the first candidate cell may include the following operation. The terminal device triggers the connection reestablishment procedure or determines the first candidate cell and performs the handover to the first candidate cell when the terminal device fails to access the target cell within a third duration.

Optionally, the third duration may be determined based on the pre-configuration information of the terminal device, or may be configured by the network device for the terminal device, or may be defined in the protocol. Optionally, a timer corresponding to the third duration may be the timer T304. Optionally, a starting time of the third duration may be the same as or different from the starting time of the first duration. Optionally, the third duration may be configured by the source network device through the RRC signaling.

Optionally, when the terminal device fails to access the target cell, the terminal device triggers the connection reestablishment procedure or the terminal device determines the first candidate cell and performs the handover to the first candidate cell, which may include the following operation. The terminal device fails to access the target cell based on one or more access methods other than the random access procedure; or the terminal device fails to access the target cell through the random access procedure; or the terminal device fails to access the target cell based on the random access procedure and one or more access methods other than the random access procedure.

Optionally, when the terminal device triggers the connection reestablishment procedure, the terminal device may transmit a reason for the reestablishment procedure to a specific network device.

Optionally, the first candidate cell may be a candidate cell other than the target cell. Optionally, the first candidate cell may be the target cell or a cell other than the target cell.

Optionally, the terminal device may determine a TA value of the first candidate cell and perform the handover to the first candidate cell based on the TA value of the first candidate cell, in other words, the terminal device may access the first candidate cell.

Optionally, the terminal device may perform the handover to the first candidate cell based on the TA value of the first candidate cell that is obtained before determining the first candidate cell. Optionally, the terminal device may perform the handover to the first candidate cell based on a new TA value (for example, the new TA value obtained through the random access procedure) of the first candidate cell that is obtained after determining the first candidate cell. Optionally, the terminal device may perform the handover to the first candidate cell based on the TA value of the first candidate cell transmitted by the source network device. The TA value of the first candidate cell transmitted by the source network device may be included in the handover command, or may be included in the reconfiguration message, or may be included in another signaling in the reconfiguration message.

Illustratively, the terminal device determines a third measurement result for the first candidate cell before the terminal device determines the first candidate cell. A time when the third measurement result for the first candidate cell is determined corresponds to a time when the TA value of the first candidate cell is determined. The terminal device determines a fourth measurement result for the first candidate cell when the terminal device receives the handover command from the source network device or when the terminal device is required to perform the handover. The terminal device accesses the first candidate cell through the random access procedure when an absolute value of a difference between the third measurement result and the fourth measurement result is greater than the first threshold. The terminal device performs the handover to the first candidate cell based on the TA value of the first candidate cell when the absolute value of the difference between the third measurement result and the fourth measurement result is less than or equal to the first threshold.

Illustratively, the terminal device accesses the first candidate cell through the random access procedure when the terminal device determines that a measurement result for beam information of the first candidate cell is less than or equal to a second threshold. The beam information of the first candidate cell is indicated by the first information. Alternatively, the terminal device accesses the first candidate cell through the random access procedure when the terminal device determines that no beam information with a measurement result greater than the second threshold is present in beam information of the first candidate cell.

Illustratively, the terminal device performs the handover to the first candidate cell when the terminal device determines that the measurement result for the beam information of the first candidate cell is greater than the second threshold. Alternatively, the terminal device performs the handover to the first candidate cell when the terminal device determines that beam information with a measurement result greater than the second threshold is present in the beam information of the first candidate cell.

In some embodiments, the third duration is greater than a first duration for the terminal device to access the target cell through the random access procedure.

In some embodiments, the terminal device may access the target cell through the random access procedure when the terminal device fails to access the target cell based on the TA of the target cell or through the RACH-less handover within the first duration. When the terminal device fails to access the target cell through the random access procedure within the third duration, the terminal device triggers the connection reestablishment procedure, or the terminal device determines the first candidate cell and performs the handover to the first candidate cell.

In some embodiments, a starting time of a timer corresponding to the first duration and/or the third duration is determined based on a time when the terminal device determines the target cell.

Optionally, the starting time of the timer corresponding to the first duration and/or the third duration may be the time when the terminal device determines the target cell. Optionally, the starting time of the timer corresponding to the first duration and/or the third duration may be separated from the time when the terminal device determines the target cell by one or more time units. Optionally, the starting time of the timer corresponding to the first duration and/or the third duration may be prior to or after the time when the terminal device determines the target cell; or the starting time of the timer corresponding to the first duration and/or the third duration may be the same as the time when the terminal device determines the target cell.

In some embodiments, the operation that the terminal device triggers the connection reestablishment procedure or the terminal device determines the first candidate cell and performs the handover to the first candidate cell may include the following operation. The terminal device triggers the connection reestablishment procedure or determines the first candidate cell and performs the handover to the first candidate cell when the terminal device determines that a measurement value for the beam information of the target cell is less than a third threshold.

Optionally, the third threshold may be determined based on the pre-configuration information of the terminal device, or may be configured by the network device for the terminal device, or may be defined in the protocol.

Optionally, the operation of performing the handover to the first candidate cell may include that: data information or an access request is transmitted to a network device corresponding to the first candidate cell. The data information or the access request may carry an identifier of the source cell and/or an identifier of the target cell. In this way, the network device corresponding to the first candidate cell may receive a context of the terminal device from the source network device or the target network device based on the identifier of the source cell and/or the identifier of the target cell transmitted by the terminal device.

In some embodiments, the determination of the first candidate cell includes the following operation.

The first candidate cell is determined based on a measurement result for at least one candidate cell. The at least one candidate cell is indicated by the source network device to the terminal device.

Optionally, the first candidate cell may be a candidate cell having a highest measurement result in the measurement result for the at least one candidate cell. Alternatively, the first candidate cell may be a candidate cell having a highest measurement result in measurement results for cells other than the target cell in the at least one candidate cell.

In some embodiments, the operation that the terminal device determines the target cell or the first information may include that: the terminal device receives a handover command from the source network device, and the handover command carries an identifier of the target cell or the first information.

In some other embodiments, the operation that the terminal device determines the target cell or the first information may include that: the terminal device determines the target cell or the first information based on a measurement result for the at least one candidate cell. The at least one candidate cell is indicated by the source network device to the terminal device.

In some embodiments, the first information includes at least one of: an index or an identifier of the target cell; a TA value of the target cell; a difference between a TA value of a source cell and the TA value of the target cell; beam information of the target cell; resource information configured by the target cell for the terminal device; a C-RNTI of the target cell; a RACH-less handover type indication; or an L1/L2 handover type indication.

Optionally, in some other embodiments, the difference between the TA value of the source cell and the TA value of the target cell may also be called a TA adjustment value.

Optionally, the beam information may include at least one of: a transmission configuration indication (TCI) state, an SSB index, or a CSI-RS index.

Optionally, the resource information configured by the target cell for the terminal device may include a CG resource or a DG resource.

Optionally, when the terminal device receives the handover command carrying the L1/L2 handover type indication, the terminal device performs the L1/L2 handover. Optionally, when the terminal device receives the handover command carrying the RACH-less handover type indication, the terminal device performs the RACH-less handover.

In some embodiments, the method further includes that: the terminal device stores/generates a first report when the terminal device is handed over to the first candidate cell successfully.

In some other embodiments, the method may further include that: the terminal device stores/generates a second report when the terminal device accesses the target cell through the random access successfully.

Optionally, the first report and/or the second report may include at least one of: a measurement result obtained by the terminal device from a measurement on the at least one candidate cell before determining the target cell, a measurement result obtained by the terminal device from the measurement on the at least one candidate cell after determining the target cell, the first measurement result for the target cell, the second measurement result for the target cell, the beam information of the target cell, a target cell indicated in the handover command, a target cell determined by the terminal device based on the measurement report, the TA value of the target cell, the new TA value of the target cell, or an identifier of the first candidate cell.

In some embodiments, the method may further include one of the following operations.

The terminal device transmits the first report to a network device corresponding to the first candidate cell.

The terminal device transmits the second report to a target network device.

The terminal device receives a first reporting request from a network device corresponding to the first candidate cell, and the terminal device transmits the first report to the network device corresponding to the first candidate cell.

The terminal device receives a second reporting request from a target network device, and the terminal device transmits the second report to the target network device.

The terminal device transmits, to a network device corresponding to the first candidate cell, indication information for indicating that the first report is stored, the terminal device receives a first reporting request from the network device corresponding to the first candidate cell, and the terminal device transmits the first report to the network device corresponding to the first candidate cell.

The terminal device transmits, to a target network device, indication information for indicating that the second report is stored, the terminal device receives a second reporting request from the target network device, and the terminal device transmits the second report to the target network device.

Optionally, the terminal device may report the first report to the network device corresponding to the first candidate cell or report the second report to the target network device every time the terminal device obtains the first report or the second report.

Optionally, the network device corresponding to the first candidate cell may transmit the first reporting request to the terminal device when the terminal device accesses the first candidate cell successfully. Alternatively, the terminal device transmits, to the network device corresponding to the first candidate cell, the indication information for indicating that the first report is stored.

Optionally, the target network device may transmit the second reporting request to the terminal device when the terminal device accesses the target cell successfully. Alternatively, the terminal device transmits, to the target network device, indication information for indicating that the second report is stored.

Optionally, when the network device corresponding to the first candidate cell obtains the first report, the network device corresponding to the first candidate cell may train or optimize an artificial intelligence (AI) model stored internally according to the first report. Optionally, when the target network device obtains the second report, the target network device may train or optimize an AI model stored internally according to the second report.

In some embodiments, before the terminal device accesses the target cell through the random access procedure, or the terminal device triggers the connection reestablishment procedure, or the terminal device determines the first candidate cell and performs handover to the first candidate cell, the method may further include one of the following operations.

The terminal device performs an L1/L2 handover to the target cell.

The terminal device performs a RACH-less handover to the target cell.

Optionally, the operation that the terminal device performs the L1/L2 handover to the target cell may include that: the terminal device performs the L1/L2 handover to the target cell based on the TA value of the target cell.

Optionally, the operation that the terminal device performs the RACH less handover to the target cell may include that: the terminal device performs the RACH less handover to the target cell based on a TA value of 0 for the target cell; or the terminal device performs the RACH less handover to the target cell based on the TA value of the source cell.

In the embodiments of the disclosure, a terminal device determines a target cell or first information. The first information indicates the target cell. The terminal device accesses the target cell through a random access procedure, or the terminal device triggers a connection reestablishment procedure, or the terminal device determines a first candidate cell and performs handover to the first candidate cell. In such a way, the terminal device can access the target cell through the random access procedure, or access the target cell through the connection reestablishment procedure, or access the first candidate cell, such that the terminal device can communicate in the target cell or the first candidate cell, and reliability of information transmission is improved.

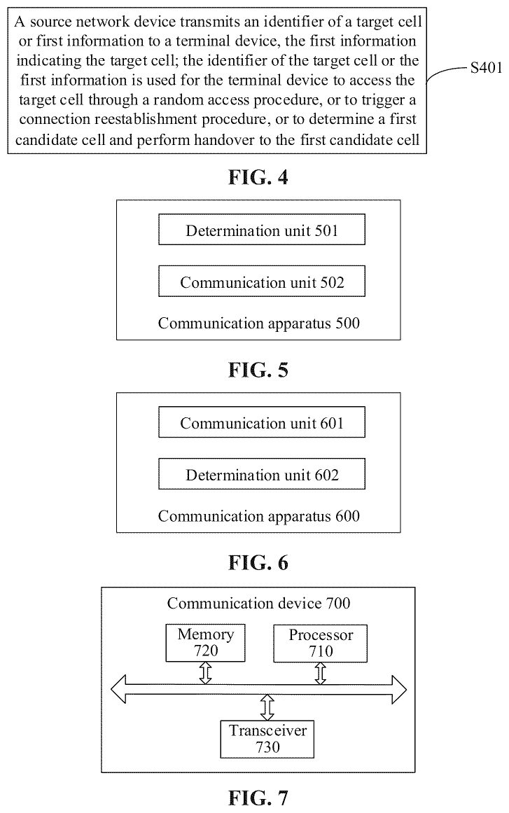

FIG. 4 is a schematic flowchart of another communication method provided in an embodiment of the disclosure. As illustrated in FIG. 4, the method includes the following operations.

At S401, a source network device transmits an identifier of a target cell or first information to a terminal device. The first information indicates the target cell.

The identifier of the target cell or the first information is configured for the terminal device to access the target cell through a random access procedure, or to trigger a connection reestablishment procedure, or to determine a first candidate cell and perform handover to the first candidate cell.

Optionally, the identifier of the target cell or the first information may be included in a handover command, or may be included in a reconfiguration message, or may be included in another signaling in the reconfiguration message.

In some embodiments, the first information includes at least one of: an index or an identifier of the target cell; a TA value of the target cell; a difference between a TA value of a source cell and the TA value of the target cell; beam information of the target cell; resource information configured by the target cell for the terminal device; a C-RNTI of the target cell; a RACH-less handover type indication; or an L1/L2 handover type indication.

In some embodiments, the UE determines the target cell and/or the first information, and initiates a handover procedure to the target cell based on the first information.

Optionally, the operation that the UE initiates the handover procedure to the target cell includes at least one of the following operations (a)-(d) (for a network-triggered handover, a behavior for receiving a handover command is referred to here).

(a) The UE transmits a first uplink message (corresponding to the second information in the above embodiments) to the target network device. The first uplink message may include at least one of: a reconfiguration completion message, a handover execution/completion MAC CE, a C-RNTI MAC CE, a BSR, data, an SR, or the like.

After the UE transmits the first uplink message, the UE monitors second downlink information (corresponding to the third information in the above embodiments) transmitted by the target network device. The second downlink information is used for responding to the first uplink message. Optionally, the UE stops a first timer and/or a second timer after receiving the second downlink information.

The handover execution/completion MAC CE is used for responding to configuration information of the target cell, that is, the UE has used the configuration information provided by the target cell.

(b) A PDCCH of the target cell is monitored. The PDCCH is used for scheduling uplink and downlink resources.

This operation is executed if the UE has no available uplink resource for transmitting the first uplink message.

(c) The first timer (a new timer, a duration corresponding to the first timer is the first duration, or the first timer may be the timer T304) is started.

The first timer is used for the UE to fall back to the random access procedure in due time, to avoid a handover failure due to an invalid TA or an unreasonable beam indication.

(d) The second timer (which may be the timer T304, and a duration corresponding to the second timer is the third duration) is started.

The second timer may be a timer in the related art, and is used for determining whether the handover is failed. The second timer is started when the UE receives the handover command, and is stopped when the handover is successful. The handover is considered to be failed when the second timer expires, and a connection reestablishment procedure is triggered. Optionally, the duration of the first timer may be less than the duration of the second timer.

In some embodiments, a behavior when the first timer expires may include at least one of the following operations (a)-(c).

(a) A 4-step random access procedure is initiated.

Optionally, if the second timer expires, the UE triggers the connection reestablishment procedure or performs operation (c).

Optionally, if no beam satisfies the condition, the UE triggers the connection reestablishment procedure or performs operation (c).

(b) A 2-step random access procedure is initiated.

Optionally, if the second timer expires, the UE triggers the connection reestablishment procedure or performs operation (c).

Optionally, if no beam satisfies the condition, the UE triggers the connection reestablishment procedure or performs operation (c).

(c) A first candidate cell is determined among the at least one candidate cell, a handover to the first candidate cell is performed, and the second timer is restarted. The at least one candidate cell is pre-configured by the network for the UE. Optionally, a time when the second timer is restarted may be determined based on a time when the first candidate cell is determined, or may be determined based on a time when the terminal device transmits a message to the network device corresponding to the first candidate cell.

Optionally, if the UE transmits, before initiating the random access procedure, the first uplink message through an uplink resource pre-configured or dynamically scheduled by the network, and stores an MAC PDU of the first uplink message in a first buffer, the UE determines a transmission mode depending on whether a grant size for transmitting an Msg3/MsgA matches a size of the first uplink message.

Optionally, if the grant size of transmitting the Msg3/MsgA payload matches the MAC PDU of the first uplink message, the UE may acquire the MAC PDU of the first uplink message from the first buffer and transmit the MAC PDU through the Msg3/MsgA. Specifically, the UE acquires the MAC PDU from the first buffer (an HARQ buffer) and stores the MAC PDU in an Msg3/A buffer.

Optionally, if the grant size for transmitting the Msg3/MsgA payload does not match the MAC PDU of the first uplink message, the UE may acquire the MAC PDU of the first uplink message from the first buffer, and instruct a multiplexing and assembly entity to reassemble the first uplink message based on the grant size of the Msg3/MsgA payload. The newly assembled first uplink message includes all or part of the MAC SDUs/MAC CEs in the original first uplink message. Specifically, the multiplexing and assembly entity is instructed to carry MAC subPDU(s) in a new transmission, and the MAC subPDU(s) includes (include) an MAC SDU in the MAC PDU.

In some embodiments, before determining the target cell, the UE determines the TA value of the target cell while starting a third timer and/or storing a current first RSRP. The first RSRP is included in a first measurement result.

Optionally, the operation that the UE determines the TA value of the target cell includes one of the following operations.

The UE receives the TA value of the target cell from the source network, such as a TA command MAC CE.

The UE determines the TA value of the target cell by itself, for example, by calculating and determining the TA value at the UE side.

Optionally, when the UE determines the TA value of the target cell, the UE may report information for determining the TA value to the source network device/the target network device. For example, the UE may determine the TA value using an RSRP or a downlink (DL) TA difference (i.e., a timing difference).

Optionally, the third timer may be used for maintaining a validity of the TA value of the target cell. The UE starts/restarts the third timer when determining the TA value of the target cell, and determines that the TA value is valid during a running period of the third timer. If the third timer expires when the UE initiates the handover to the target cell, the UE determines that the TA value is invalid, and falls back to the RACH-based handover procedure (the operation is the same as the behavior when first timer expires).

The UE may store the first RSRP at the time of determining the TA value of the target cell for the purpose of determining the validity of the TA value of the target cell. The UE determines a second RSRP when the UE initiates the handover to the target cell, and determines that the TA value of the target cell is invalid if a difference between the first RSRP and the second RSRP exceeds a pre-configured threshold (corresponding to the first threshold in the above embodiments). Then, the UE falls back to the RACH-based handover procedure. The second RSRP is included in a second measurement result.

In some embodiments, before the first timer expires, the behavior of the UE may include one of the following operations (a)-(b).

(a) The UE determines whether a beam indicated by the first information satisfies a first threshold (corresponding to the second threshold in the above embodiments). If the beam indicated by the first information does not satisfy the first threshold, the UE considers that the first timer expires. In other words, if the beam indicated by the first information does not satisfy the first threshold, the terminal device accesses the target cell through the random access procedure.

(b) The UE determines whether a beam satisfying the first threshold is present in the target cell, and if no beam satisfying the first threshold is present in the target cell, the first timer is considered to be expired. In other words, if no beam satisfying the first threshold is present in the target cell, the terminal device accesses the target cell through the random access procedure.

In some embodiments, a stop condition of the first timer may include that: the UE receives a first downlink message from the target network device. The first downlink message may be any message carried by a PDCCH or a PDSCH. Optionally, the first downlink message may be a UE contention resolution identity MAC CE.

In some embodiments, the first information includes at least one of: an index of a serving cell, which may also be referred to as an index of the target cell; TA information of the target cell, which may include the TA value of the target cell or the TA adjustment value of the target cell; beam information of the target cell, which may include at least one of: a TCI state of the target cell, an SSB index of the target cell, or a CSI-RS index of the target cell; a first resource or an identifier of the first resource, which may include a CG resource, or a DG resource; a C-RNTI of the target cell; a RACH-less handover type indication; or a L1/L2 handover type indication.

The first resource may be the resource information configured by the target cell for the terminal device in the above embodiments.

In some embodiments, the operation that UE determines the target cell may include one of the following operations (a) and (b).

(a) A network-based (NW-based) operation: the UE receives a handover command indicating the target cell.

(b) A UE-based operation: the UE determines the target cell based on a condition/measurement event.

In some embodiments, the UE stores/generates a first report when the UE is handed over to the first candidate cell successfully.

In some embodiments, the UE stores/generates a second report when the UE initiates a successful random access to the target cell.

In some embodiments, the UE reports to the network that the first report and/or the second report are currently stored, and reports the first report and/or the second report based on indication information from the network side.

In the embodiments of the disclosure, the terminal device may fall back to the random access procedure in advance to avoid a connection reestablishment due to handover failure.

The embodiments of the disclosure provide a timer-based method for falling back to a random access procedure, including that the UE determines whether to perform the RACH-less handover or the L1/L2 handover, or to perform the RACH-based handover procedure based on the first timer and/or the validity of the TA value.

Preferred embodiments of the disclosure have been described in detail above with reference to the accompanying drawings. However, the disclosure is not limited to the specific details in the above embodiments. Various simple modifications may be made to the technical solutions in the disclosure within the scope of the technical conception of the disclosure, and these simple modifications shall fall within the scope of protection of the disclosure. For example, various specific technical features described in the above specific embodiments may be combined in any suitable manner without contradiction, and various possible combinations are not further described in the disclosure in order to avoid unnecessary repetition. For another example, various implementations of the disclosure may also be arbitrarily combined with each other as long as the combination does not depart from the idea of the disclosure, and they shall also be considered as the content of the disclosure. For another example, various embodiments described in the disclosure and/or the technical features in the embodiments may be combined with the prior art in any manner on the premise of no conflict, and the combined technical solution should also fall within the scope of protection of the disclosure.

It should be understood that in various method embodiments of the disclosure, the sequence number of the above-mentioned operation does not mean an order of execution, and the execution order of the operations is determined by their functions and inherent logic, which should not be limited in any way to the implementation process of the embodiments of the disclosure. Further, in the embodiments of the disclosure, the terms “downlink”, “uplink” and “sidelink” each represents a transmission direction of a signal or data. The term “downlink” represents that the transmission direction of the signal or data is a first direction from a site to a UE in a cell, the term “uplink” represents that the transmission direction of the signal or data is a second direction from the UE in the cell to the site, and the term “sidelink” represents that the transmission direction of the signal or data is a third direction from a first UE to a second UE. For example, the “downlink signal” means that the transmission direction of the signal is the first direction. In addition, in the embodiments of the disclosure, the term “and/or” herein is only used to describe an association relationship between associated objects, and represents that three relationships may exist. Specifically, A and/or B may represent three conditions: i.e., independent existence of A, existence of both A and B and independent existence of B. In addition, the character “/” in the disclosure usually represents that previous and next associated objects form an “or” relationship.

FIG. 5 is a schematic diagram of a structural composition of a communication apparatus provided in an embodiment of the disclosure. As illustrated in FIG. 5, the communication apparatus 500 may be applied to a terminal device or may be a terminal device, and the communication apparatus 500 includes a determination unit 501 and a communication unit 502.

The determination unit 501 is configured to determine a target cell or first information. The first information indicates the target cell.

The communication unit 502 is configured to: access the target cell through a random access procedure, or trigger a connection reestablishment procedure, or perform handover to a determined first candidate cell.

In some embodiments, the communication unit 502 is further configured to: access the target cell through the random access procedure when failing to access the target cell within a first duration.

In some embodiments, the random access procedure includes a four-step random access procedure or a two-step random access procedure.

In some embodiments, the communication unit 502 is further configured to: receive no third information from a target network device after transmitting second information to the target network device.

In some embodiments, the communication unit 502 is further configured to: monitor no PDCCH or PDSCH transmitted by the target network device.

In some embodiments, the second information includes at least one of: a reconfiguration completion message, a handover execution/completion MAC CE, a C-RNTI MAC CE, a BSR, a data message, or an SR.

In some embodiments, the third information includes at least one of: a contention resolution identity MAC CE of UE, or downlink information.

In some embodiments, the communication unit 502 is further configured to: transmit an Msg3/MsgA to the target network device; and when a grant size for transmitting an Msg3/MsgA payload is greater than or equal to an uplink MAC PDU, transmit the uplink MAC PDU to the target network device through the Msg3/MsgA.

In some embodiments, the communication unit 502 is further configured to: transmit an Msg3/MsgA to the target network device; and when a grant size for transmitting an Msg3/MsgA payload is less than an uplink MAC PDU, determine part or all of MAC SDUs and/or part or all of MAC CEs from the uplink MAC PDU, and transmit the part or all of the MAC SDUs and/or the part or all of the MAC CEs to the target network device through the Msg3/MsgA.

In some embodiments, the determination unit 501 is further configured to: determine a TA value of the target cell; and the communication unit 502 is further configured to: access the target cell through the random access procedure after a second duration has elapsed from a time when the TA value of the target cell is determined.

In some embodiments, the communication unit 502 is further configured to: when failing to access the target cell based on the TA value of the target cell within a second duration from the time when the TA value of the target cell is determined, access the target cell through the random access procedure after the second duration has elapsed.

In some embodiments, the communication unit 502 is further configured to: receive the TA value of the target cell from the source network device.

In some embodiments, the communication unit 502 is further configured to: transmit an uplink reference signal to the source network device, and receive the TA value of the target cell from the source network device.

In some embodiments, the determination unit 501 is further configured to: determine the TA value of the target cell based on a first measurement result for the target cell.

In some embodiments, the determination unit 501 is further configured to: determine the TA value of the target cell based on a TA value of a source cell and a difference between the TA value of the source cell and the TA value of the target cell.

In some embodiments, the determination unit 501 is further configured to: determine the TA value of the target cell through the random access procedure.

In some embodiments, the determination unit 501 is further configured to: determine a first measurement result for the target cell before determining the target cell or the first information. A time when determining the first measurement result for the target cell corresponds to a time when determining the TA value of the target cell. The determination unit is further configured to: determine a second measurement result for the target cell when receiving a handover command from a source network device or when it is required to perform the handover.

The communication unit 502 is further configured to: access the target cell through the random access procedure when an absolute value of a difference between the first measurement result and the second measurement result is greater than a first threshold.

In some embodiments, the communication unit 502 is further configured to: perform the handover to the target cell when the absolute value of the difference between the first measurement result and the second measurement result is less than or equal to the first threshold.

In some embodiments, the communication unit 502 is further configured to: access the target cell through the random access procedure when determining that a measurement result for beam information of the target cell is less than or equal to a second threshold. The beam information of the target cell is indicated by the first information.

In some embodiments, the communication unit 502 is further configured to: access the target cell through the random access procedure when determining that no beam information with a measurement result greater than a second threshold is present in beam information of the target cell.

In some embodiments, the communication unit 502 is further configured to: perform the handover to the target cell when determining that the measurement result for the beam information of the target cell is greater than the second threshold.

In some embodiments, the communication unit 502 is further configured to: perform the handover to the target cell when determining that beam information with a measurement result greater than the second threshold is present in the beam information of the target cell.

In some embodiments, the communication unit 502 is further configured to: trigger the connection reestablishment procedure, or determine the first candidate cell and perform the handover to the first candidate cell, when failing to access the target cell within a third duration.

In some embodiments, the third duration is greater than a first duration for the communication apparatus 500 to access the target cell through the random access procedure.

In some embodiments, a starting time of a timer corresponding to the first duration and/or the third duration is determined based on a time when the communication apparatus 500 determines the target cell.

In some embodiments, the communication unit 502 is further configured to: trigger the connection reestablishment procedure, or determine the first candidate cell and perform the handover to the first candidate cell, when determining that a measurement value of beam information of the target cell is less than a third threshold.

In some embodiments, the determination unit 501 is further configured to: determine the first candidate cell based on a measurement result for at least one candidate cell. The at least one candidate cell is indicated by the source network device to the communication apparatus 500.

In some embodiments, the communication unit 502 is further configured to: receive a handover command from a source network device. The handover command carries an identifier of the target cell or the first information.

In some embodiments, the determination unit 501 is further configured to: determine the target cell or the first information based on a measurement result for at least one candidate cell. The at least one candidate cell is indicated by a source network device to the communication apparatus 500.

In some embodiments, the first information includes at least one of: an index or an identifier of the target cell; a TA value of the target cell; a difference between a TA value of a source cell and the TA value of the target cell; beam information of the target cell; resource information configured by the target cell for the communication apparatus 500; a C-RNTI of the target cell; a RACH-less handover type indication; or an L1/L2 handover type indication.

In some embodiments, the communication apparatus 500 further includes a storage unit. The storage unit is configured to store/generate a first report when the handover to the first candidate cell is successful; or to store/generate a second report when a random access to the target cell is successful.

In some embodiments, the communication unit 502 is further configured to perform one of: transmitting the first report to a network device corresponding to the first candidate cell; transmitting the second report to a target network device; receiving a first reporting request from a network device corresponding to the first candidate cell, and transmitting the first report to the network device corresponding to the first candidate cell; receiving a second reporting request from a target network device, and transmitting the second report to the target network device; transmitting, to a network device corresponding to the first candidate cell, indication information for indicating that the first report is stored, receiving a first reporting request from the network device corresponding to the first candidate cell, and transmitting the first report to the network device corresponding to the first candidate cell; or transmitting, to a target network device, indication information for indicating that the second report is stored, receiving a second reporting request from the target network device, and transmitting the second report to the target network device.

In some embodiments, the communication unit 502 is further configured to: perform an L1/L2 handover to the target cell; or perform a RACH less handover to the target cell.

FIG. 6 is a schematic diagram of a structural composition of another communication apparatus provided in an embodiment of the disclosure. As illustrated in FIG. 6, the communication apparatus 600 may be applied to a source network device or may be a source network device, and the communication apparatus 600 includes a communication unit 601.

The communication unit 601 is configured to: transmit an identifier of a target cell or first information to a terminal device. The first information indicates the target cell.

The identifier of the target cell or the first information is configured for the terminal device to access the target cell through a random access procedure, or to trigger a connection reestablishment procedure, or to determine a first candidate cell and perform handover to the first candidate cell.

In some embodiments, the communication apparatus 600 further includes a determination unit 602 configured to determine the identifier of the target cell or the first information.

In some embodiments, the first information includes at least one of: an index or an identifier of the target cell; a TA value of the target cell; a difference between a TA value of a source cell and the TA value of the target cell; beam information of the target cell; resource information configured by the target cell for the terminal device; a C-RNTI of the target cell; a RACH-less handover type indication; or an L1/L2 handover type indication.

It should be understood by a person of ordinary skill in the art that the relevant description of the above communication apparatuses in the embodiments of the disclosure may be understood with reference to the relevant description of the communication methods in the embodiments of the disclosure.

FIG. 7 is a schematic structural diagram of a communication device provided in an embodiment of the disclosure. The communication device 700 may include one of a terminal device or a source network device. The communication device 700 illustrated in FIG. 7 may include a processor 710 and a memory 720. The memory 720 stores a computer program executable on the processor 710, and the processor 710 is configured to execute the computer program to perform the communication method in any of the above embodiments.

Optionally, the memory 720 may be a separate device independent from the processor 710, or may be integrated into the processor 710.

In some embodiments, as illustrated in FIG. 7, the communication device 700 may further include a transceiver 730. The processor 710 may control the transceiver 730 to communicate with other devices, specifically, to transmit information or data to other devices, or receive information or data from other devices.

The transceiver 730 may include a transmitter and a receiver. The transceiver 730 may further include an antenna, and there may be one or more antennas.

In some embodiments, the communication device 700 may specifically be the terminal device or the source network device in the embodiments of the disclosure. The communication device 700 may implement corresponding flows that are implemented by the terminal device or the source network device in various methods in the embodiments of the disclosure. For brevity, details are not elaborated herein again.

There is provided a computer storage medium in an embodiment of the disclosure. The computer storage medium stores one or more programs that, when executed by one or more processors, cause the one or more processors to perform the communication method in any of the embodiments of the disclosure.

In some embodiments, the computer-readable storage medium may be applied to the terminal device or the source network device in the embodiments of the disclosure, and the computer program causes a computer to perform corresponding flows that are performed by the terminal device or the source network device in various methods in the embodiments of the disclosure. For brevity, details are not elaborated herein again.

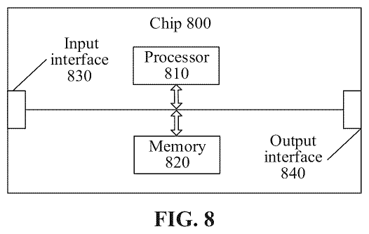

FIG. 8 is a schematic structural diagram of a chip in an embodiment of the disclosure. The chip 800 illustrated in FIG. 8 includes a processor 810. The processor 810 is configured to call a computer program from a memory and run the computer program to perform the method according to any of the embodiments of the disclosure.

In some embodiments, as illustrated in FIG. 8, the chip 800 may further include a memory 820. The processor 810 may be configured to call the computer program stored in the memory 820 and run the computer program to perform the method according to the embodiments of the disclosure.

The memory 820 may be a separate device independent from the processor 810, or may be integrated into the processor 810.

In some embodiments, the chip 800 may further include an input interface 830. The processor 810 may control the input interface 830 to communicate with other devices or chips, specifically, to obtain information or data from other devices or chips.

In some embodiments, the chip 800 may further include an output interface 840. The processor 810 may control the output interface 840 to communicate with other devices or chips, specifically, to output information or data to other devices or chips.

In some embodiments, the chip may be applied to the terminal device or the source network device in the embodiments of the disclosure, and the chip may perform corresponding flows that are performed by the terminal device or the source network device in various methods in the embodiments of the disclosure. For brevity, details are not elaborated herein again.

It should be understood that, the chip mentioned in the embodiments of the disclosure may also be referred to as a system-level chip, a system chip, a chip system or a system on chip, etc.

There is provided a computer program product in an embodiment of the disclosure. The computer program product includes a computer storage medium storing a computer program, and the computer program includes instructions executable by at least one processor. The at least one processor is configured to perform the communication method in any of the embodiments of the disclosure when executing the instructions.

In some embodiments, the computer program product may be applied to the terminal device or the source network device in the embodiments of the disclosure, and the computer program instructions cause a computer to perform corresponding flows that are performed by the terminal device or the source network device in various methods in the embodiments of the disclosure. For brevity, details are not elaborated herein again.

Optionally, the computer program product in the embodiment of the disclosure may also be referred to as a software product in other embodiments.

There is provided a computer program in an embodiment of the disclosure, and the computer program causes a computer to perform the communication method in any of the embodiments of the disclosure.

In some embodiments, the computer program may be applied to the terminal device or the source network device in the embodiments of the disclosure. The computer program, when being run on a computer, causes the computer to perform corresponding flows that are performed by the terminal device or the source network device in various methods in the embodiments of the disclosure. For brevity, details are not elaborated herein again.

The processor, the communication apparatus, or the chip in the embodiments of the disclosure may be an integrated circuit chip having a signal processing capability. During implementation, the steps of the foregoing method embodiments may be implemented by using an integrated logic circuit in a hardware form in the processor or implemented by using instructions in a software form. The processor, the communication apparatus, or the chip described above may include an integration of any one or more of: a general purpose processor, an application specific integrated circuit (ASIC), a digital signal processor (DSP), a digital signal processing device (DSPD), a programmable logic device (PLD), a field programmable gate array (FPGA), a central processing unit (CPU), a graphics processing unit (GPU), an embedded neural-network processing unit (NPU), a controller, a microcontroller, a microprocessor, a programmable logic device, a discrete gate or a transistor logic device, or a discrete hardware component, which is configured to implement or perform methods, steps and logical blocks disclosed in the embodiments of the disclosure. The general purpose processor may be a microprocessor or the processor may be any conventional processor and the like. Steps of the methods disclosed with reference to the embodiments of the disclosure may be directly executed and completed by means of a hardware decoding processor, or may be executed and completed by using a combination of hardware in the decoding processor and software modules. The software module may be located in a mature storage medium in the field, such as a random access memory (RAM), a flash memory, a read-only memory (ROM), a programmable ROM (PROM), an electrically-crasable programmable memory, or a register. The storage medium is located in the memory, and the processor reads information in the memory and completes the steps in the foregoing methods in combination with a hardware of the processor.

It can be understood that, the memory or the computer storage medium in the embodiments of the disclosure may be a volatile memory or a non-volatile memory, or may include both a volatile memory and a non-volatile memory. The non-volatile memory may be an ROM, a PROM, an crasable PROM (EPROM), an electrically EPROM (EEPROM) or a flash memory. The volatile memory may be an RAM and is used as an external cache. By way of illustration, but not limitation, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM) and a direct rambus RAM (DR RAM). It should be noted that, the memory in the system and method described herein aims to include but not be limited to these memories and any other suitable types of memories.

It should be understood that, the foregoing memory or the computer storage medium is exemplary but not limited description, for example, the memory in the embodiments of the disclosure may be an SRAM, a DRAM, an SDRAM, a DDR SDRAM, an ESDRAM, an SLDRAM and a DR RAM, etc. It should be noted that, the memory in the embodiments of the disclosure aims to include but not be limited to these memories and any other suitable types of memories.

A person of ordinary skill in the art may be aware that, units and algorithm steps of various examples described in combination with the embodiments disclosed herein may be implemented by electronic hardware, or a combination of computer software and electronic hardware. Whether the functions are performed by hardware or software depends on particular applications and design constraint conditions of the technical solutions. Those skilled in the art may use different methods to implement the described functions for each particular application, and such implementations should not be considered to go beyond the scope of this application.

It may be clearly understood by those skilled in the art that, for the purpose of convenient and brief description, the detailed working process of the foregoing system, apparatus, and units may refer to the corresponding process in the foregoing method embodiments, and details are not described herein again.

In the several embodiments provided in this disclosure, it should be understood that the disclosed system, apparatus, and method may be implemented in other manners. For example, the described apparatus embodiments are merely exemplary. For example, the unit division is merely a logical function division and there may be other divisions in actual implementation. For example, multiple units or components may be combined or integrated into another system, or some features may be ignored or not performed. In addition, the displayed or discussed mutual coupling or direct coupling or communication connection may be an indirect coupling or communication connection implemented through some interfaces, apparatuses or units, and may be implemented in electrical, mechanical or other forms.

The units described as separate parts may be or may not be physically separate, and parts displayed as units may be or may not be physical units, they may be located in one place, or may be distributed on multiple network units. Some or all of the units may be selected according to actual needs to achieve the objectives of the solutions of the embodiments.

In addition, functional units in the embodiments of the disclosure may be integrated into one processing unit, or each of the units may exist physically and separately, or two or more units are integrated into one unit.

In any of the embodiments of the disclosure, a time interval, a time period, a time range, a duration, a time window, etc. may include all of the endpoint times, or may include part of the endpoint times (for example, including the left endpoint time but not including the right endpoint time, or including the right endpoint time but not including the left endpoint time), or may not include the endpoint time.

When the functions are implemented in form of a software functional module and sold or used as an independent product, the functions may be stored in a computer-readable storage medium. Based on such an understanding, the technical solutions of this application essentially, or the part contributing to the prior art, or part of the technical solutions may be embodied in the form of a software product. The computer software product is stored in a storage medium, and includes several instructions for instructing a computer device (which may be a personal computer, a server, a network device, and the like) to perform all or a part of the steps of the method described in the embodiments of the disclosure. The foregoing storage medium includes: any medium that can store program codes, such as a USB flash disk, a removable hard disk, an ROM, an RAM, a magnetic disk, or an optical disk.

The foregoing descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure shall be subject to the scope of protection of the claims.

1. A communication method, comprising:
determining, by a terminal device, a target cell or first information, wherein the first information indicates the target cell; and
accessing, by the terminal device, the target cell through a random access procedure, or triggering, by the terminal device, a connection reestablishment procedure, or determining, by the terminal device, a first candidate cell and performing handover to the first candidate cell.

2. The method of claim 1, wherein accessing, by the terminal device, the target cell through the random access procedure comprises:
when the terminal device fails to access the target cell within a first duration, accessing, by the terminal device, the target cell through the random access procedure, wherein a starting time of a timer corresponding to the first duration is determined based on a time when the terminal device determines the target cell.

3. The method of claim 2, wherein the terminal device failing to access the target cell comprises one of:
the terminal device receiving no third information from a target network device after transmitting second information to the target network device; or
the terminal device monitoring no physical downlink control channel (PDCCH) or physical downlink shared channel (PDSCH) transmitted by the target network device.

4. The method of claim 3, wherein
the second information comprises at least one of: a reconfiguration completion message, a handover execution/completion media access control (MAC) control element (CE), a cell radio network temporary identity (C-RNTI) MAC CE, a buffer status report (BSR), a data message, or a scheduling request (SR), and/or
the third information comprises at least one of: a contention resolution identity MAC CE of the terminal device, or downlink information.

5. The method of claim 3, wherein accessing, by the terminal device, the target cell through the random access procedure comprises:
transmitting, by the terminal device, an Msg3/MsgA to the target network device; and when a grant size for transmitting an Msg3/MsgA payload is greater than or equal to an uplink MAC protocol data unit (PDU), transmitting the uplink MAC PDU to the target network device through the Msg3/MsgA,
or
transmitting, by the terminal device, an Msg3/MsgA to the target network device; and when a grant size for transmitting an Msg3/MsgA payload is less than an uplink MAC PDU, determining part or all of MAC service data units (SDUs) and/or part or all of MAC CEs from the uplink MAC PDU, and transmitting the part or all of the MAC SDUs and/or the part or all of the MAC CEs to the target network device through the Msg3/MsgA.

6. The method of claim 1, further comprising:
determining, by the terminal device, a first measurement result for the target cell before the terminal device determines the target cell or the first information, wherein a time when the terminal device determines the first measurement result for the target cell corresponds to a time when the terminal device determines a timing advance (TA) value of the target cell;
when the terminal device receives a handover command from a source network device or when the terminal device is required to perform a handover, determining, by the terminal device, a second measurement result for the target cell; and
when an absolute value of a difference between the first measurement result and the second measurement result is greater than a first threshold, accessing, by the terminal device, the target cell through the random access procedure,
or
when an absolute value of a difference between the first measurement result and the second measurement result is less than or equal to a first threshold, performing, by the terminal device, the handover to the target cell.

7. The method of claim 1, wherein triggering, by the terminal device, the connection reestablishment procedure, or determining, by the terminal device, the first candidate cell and performing the handover to the first candidate cell comprises:
when the terminal device fails to access the target cell within a third duration, triggering the connection reestablishment procedure, or determining the first candidate cell and performing the handover to the first candidate cell,
wherein the third duration is greater than a first duration for the terminal device to access the target cell through the random access procedure, and/or
wherein a starting time of a timer corresponding to the first duration and/or the third duration is determined based on a time when the terminal device determines the target cell.

8. The method of claim 1, wherein determining the first candidate cell comprises:
determining the first candidate cell based on a measurement result for at least one candidate cell, wherein the at least one candidate cell is indicated by a source network device to the terminal device.

9. The method of claim 1, wherein the first information comprises at least one of:
an index or an identifier of the target cell;
a TA value of the target cell;
a difference between a TA value of a source cell and the TA value of the target cell;
beam information of the target cell;
resource information configured by the target cell for the terminal device;
a C-RNTI of the target cell;
a random access channel (RACH)-less handover type indication; or
a layer1/layer2 (L1/L2) handover type indication.

10. A terminal device, comprising:
a processor; and
a memory for storing a computer program executable on the processor,
wherein the processor is configured to execute the computer program to cause the terminal device to:
determine a target cell or first information, wherein the first information indicates the target cell; and
access the target cell through a random access procedure, or trigger a connection reestablishment procedure, or perform handover to a first candidate cell determined by the terminal device.

11. The terminal device of claim 10, wherein the processor is further configured to execute the computer program to cause the terminal device to:
determine a timing advance (TA) value of the target cell; and
access the target cell through the random access procedure after a second duration has elapsed from a time when the terminal device determines the TA value of the target cell.

12. The terminal device of claim 11, wherein
the processor is further configured to execute the computer program to cause the terminal device to: when the terminal device fails to access the target cell based on the TA value of the target cell within the second duration from the time when the terminal device determines the TA value of the target cell, access the target cell through the random access procedure after the second duration has elapsed,
and/or
the processor is further configured to execute the computer program to cause the terminal device to perform one of: receiving the TA value of the target cell from a source network device; transmitting an uplink reference signal to a source network device, and receiving the TA value of the target cell from the source network device; determining the TA value of the target cell based on a first measurement result for the target cell; determining the TA value of the target cell based on a TA value of a source cell and a difference between the TA value of the source cell and the TA value of the target cell; or determining the TA value of the target cell through the random access procedure.

13. The terminal device of claim 10, wherein the processor is further configured to execute the computer program to cause the terminal device to perform one of:
when the terminal device determines that a measurement result for beam information of the target cell is less than or equal to a second threshold, accessing the target cell through the random access procedure, wherein the beam information of the target cell is indicated by the first information;
when the terminal device determines that no beam information with a measurement result greater than a second threshold is present in beam information of the target cell, accessing the target cell through the random access procedure;
when the terminal device determines that a measurement result for beam information of the target cell is greater than a second threshold, performing handover to the target cell; or
when the terminal device determines that beam information with a measurement result greater than a second threshold is present in beam information of the target cell, performing handover to the target cell.

14. The terminal device of claim 10, wherein the processor is further configured to execute the computer program to cause the terminal device to:
when the terminal device determines that a measurement value of beam information of the target cell is less than a third threshold, trigger the connection reestablishment procedure, or determine the first candidate cell and perform the handover to the first candidate cell.

15. The terminal device of claim 10, wherein the processor is further configured to execute the computer program to cause the terminal device to:
receive a handover command from a source network device, wherein the handover command carries an identifier of the target cell or the first information; or
determine the target cell or the first information based on a measurement result for at least one candidate cell, wherein the at least one candidate cell is indicated by a source network device to the terminal device.

16. The terminal device of claim 10, wherein the processor is further configured to execute the computer program to cause the terminal device to:
when the terminal device is handed over successfully to the first candidate cell, store/generate a first report; or,
when the terminal device accesses the target cell successfully, store/generate a second report.

17. The terminal device of claim 16, wherein the processor is further configured to execute the computer program to cause the terminal device to perform one of:
transmitting the first report to a network device corresponding to the first candidate cell;
transmitting the second report to a target network device;
receiving a first reporting request from a network device corresponding to the first candidate cell, and transmitting the first report to the network device corresponding to the first candidate cell;
receiving a second reporting request from a target network device, and transmitting the second report to the target network device;
transmitting, to a network device corresponding to the first candidate cell, indication information for indicating that the first report is stored, receiving a first reporting request from the network device corresponding to the first candidate cell, and transmitting the first report to the network device corresponding to the first candidate cell; or
transmitting, to a target network device, indication information for indicating that the second report is stored, receiving a second reporting request from the target network device, and transmitting the second report to the target network device.

18. The terminal device of claim 10, wherein the processor is further configured to execute the computer program to cause the terminal device to:
before accessing the target cell through the random access procedure, or triggering the connection reestablishment procedure, or performing the handover to the first candidate cell,
perform an L1/L2 handover to the target cell; or
perform a RACH-less handover to the target cell.

19. A network device, comprising:
a processor; and
a memory for storing a computer program executable on the processor,
wherein the processor is configured to execute the computer program to cause the network device to:
transmit an identifier of a target cell or first information to a terminal device, wherein the first information indicates the target cell; and
the identifier of the target cell or the first information is configured for the terminal device to access the target cell through a random access procedure, or to trigger a connection reestablishment procedure, or to determine a first candidate cell and perform handover to the first candidate cell.

20. The network device of claim 19, wherein the first information comprises at least one of:
an index or an identifier of the target cell;
a timing advance (TA) value of the target cell;
a difference between a TA value of a source cell and the TA value of the target cell;
beam information of the target cell;
resource information configured by the target cell for the terminal device;
a cell radio network temporary identity (C-RNTI) of the target cell;
a random access channel (RACH)-less handover type indication; or
a layer1/layer2 (L1/L2) handover type indication.
